(19) United States
(12) Patent Application Publication
(10) Pub. No.: US 2025/0271868 A1
(43) Pub. Date: Aug. 28, 2025

(54) ALTERNATE LANDING POSITION PLANNING METHOD, LANDING PLATFORM AND AERIAL VEHICLE CONTROL METHOD, DEVICE, SYSTEM, AND MEDIUM

(71) Applicant: SZ DJI TECHNOLOGY CO., LTD., Shenzhen (CN)

(72) Inventors: Junyu WANG, Shenzhen (CN); Qi ZHOU, Shenzhen (CN)

(21) Appl. No.: 19/197,590

(22) Filed: May 2, 2025

Related U.S. Application Data
(63) Continuation of application No. PCT/CN2022/133633, filed on Nov. 23, 2022.

(51) Int. Cl. G05D 1/654; B64F 1/00; G05D 1/223; G05D 1/224; G05D 109/20; G05D 111/10

(52) U.S. Cl. CPC G05D 1/654; B64F 1/00; G05D 1/223; G05D 1/2246; G05D 2109/20; G05D 2111/10

(57) ABSTRACT

An alternate landing planning method includes obtaining an alternate landing position configuration instruction to set an alternate landing position other than a primary landing position of an aerial vehicle and determining, according to the alternate landing position configuration instruction, a current parking position of the aerial vehicle as the alternate landing position.

### CROSS-REFERENCE TO RELATED APPLICATION

The present disclosure is a continuation of International Application No. PCT/CN2022/133633, filed Nov. 23, 2022, the entire content of which is incorporated herein by reference.

### TECHNICAL FIELD

The present disclosure relates to the aerial vehicle technology field and, more particularly, to an alternate landing position planning method for an aerial vehicle, a landing platform control method, an aerial vehicle control method, a control device, a control system, and a storage medium.

### BACKGROUND

In an aerial vehicle application scenario without human monitoring, in order to realize continuous and autonomous operations, an unmanned aerial vehicle (UAV) needs to be able to autonomously land at a base station to perform a task such as power replenishment and battery replacement, and then take off again for operations after the task is completed. Due to insufficient UAV control capabilities or restricted landing scenarios, the UAV lacks the safety guarantee when landing. Thus, the UAV often has landing failures and safety accidents.

### SUMMARY

In accordance with the disclosure, there is provided an alternate landing planning. The method includes obtaining an alternate landing position configuration instruction to set an alternate landing position other than a primary landing position of an aerial vehicle and determining, according to the alternate landing position configuration instruction, a current parking position of the aerial vehicle as the alternate landing position.

Also in accordance with the disclosure, there is provided a landing platform control method. The method includes collecting orientation information of a propeller blade of an aerial vehicle parked at a landing platform and generating a control instruction based on the orientation information of the propeller blade. The control instruction is used to control the propeller blade to stop rotating in a preset area.

Also in accordance with the disclosure, there is provided a control device including one or more memories storing instructions and one or more processors. The one or more processors operate separately or together to execute the instructions to obtain an alternate landing position configuration instruction to set an alternate landing position other than a primary landing position of an aerial vehicle and determine, according to the alternate landing position configuration instruction, a current parking position of the aerial vehicle as the alternate landing position.

### BRIEF DESCRIPTION OF THE DRAWINGS

FIG. 1 is a schematic diagram showing an application scenario for an alternate landing position planning method of an aerial vehicle consistent with an embodiment of the present disclosure.

FIG. 2 is a schematic flowchart of an alternate landing position planning method of an aerial vehicle consistent with an embodiment of the present disclosure.

FIG. 3 is a schematic diagram of a control interface of an aerial vehicle consistent with an embodiment of the present disclosure.

FIG. 4 is a schematic diagram showing a scenario of determining an alternate landing position of an aerial vehicle consistent with an embodiment of the present disclosure.

FIG. 5 is a schematic diagram of another control interface of an aerial vehicle consistent with an embodiment of the present disclosure.

FIG. 6 is a schematic diagram of another control interface of an aerial vehicle consistent with an embodiment of the present disclosure.

FIG. 7 is a schematic diagram showing setting a height parameter consistent with an embodiment of the present disclosure.

FIG. 8 is a schematic flowchart showing planning a landing position of an aerial vehicle consistent with an embodiment of the present disclosure.

FIG. 9 is a schematic flowchart of a landing platform control method consistent with an embodiment of the present disclosure.

FIG. 10A is a schematic diagram showing an orientation of a propeller being not in a preset area consistent with an embodiment of the present disclosure.

FIG. 10B to FIG. 10F are schematic diagrams each showing an orientation of a propeller being in a preset area consistent with an embodiment of the present disclosure.

FIG. 11 is a schematic flowchart of a landing platform control method consistent with an embodiment of the present disclosure.

FIG. 12 is a schematic flowchart of a control method of an aerial vehicle consistent with an embodiment of the present disclosure.

FIG. 13 is a schematic flowchart of a landing method of an aerial vehicle consistent with an embodiment of the present disclosure.

FIG. 14 is a schematic structural diagram of a control device consistent with an embodiment of the present disclosure.

### REFERENCE NUMERALS

100 Aerial vehicle 110 Body 120 Power system
121 Propeller base 122 Propeller blade 130 Positioning sensor
140 Arm 200 Landing platform 210 Cabin cover
220 Carrying platform 230 External positioning sensor
Primary landing position point A Alternate landing position point B
300 Primary landing position area 400 Alternate landing position area 400
500 Control device 501 Processor 502 Memory
503 Bus

### DETAILED DESCRIPTION OF THE EMBODIMENTS

The technical solutions of embodiments of the present disclosure are described in detail in connection with the accompanying drawings of embodiments of the present disclosure. Embodiments of the present disclosure are some embodiments of the present disclosure, not all embodiments. Based on embodiments of the present disclosure, all other embodiments obtained by those of ordinary skill in the art without creative efforts are within the scope of the present disclosure.

The flowcharts shown in the accompanying drawings are for illustration only, do not necessarily include all contents and operations/steps, and do not need to be performed in the order described. For example, some operations/steps can also be divided, combined, or partially combined. Thus, an actual execution order can be changed according to the actual situation.

Unless otherwise specified, all technical and scientific terms used herein have the same meaning as commonly understood by those skilled in the art. The terms used in this specification are merely for the purpose of describing specific embodiments and are not intended to limit the present disclosure. The term “and/or” used herein can include any and all combinations of one or more of the related listed items.

Additionally, an orientation term such as upper, lower, front, and rear in embodiments of the present disclosure can be based on the conventional operating posture of an aerial vehicle and should not be considered limiting.

Embodiments of the present disclosure are described in detail in connection with the accompanying drawings. Where there is no conflict, the following embodiments and features can be combined with each other.

The aerial vehicle is increasingly and commonly used and covers more and more fields, such as surveying, security, inspection, energy, emergency, power, forestry, and agriculture. In an unmanned scenario, when an aerial vehicle autonomously lands, various actual operation environments can directly cause the aerial vehicle to have landing failures. For example, the landing point can be abnormal and cannot support the landing of the aerial vehicle. Then, the aerial vehicle can directly fall or land at an inappropriate position due to low power to cause a large loss.

To solve the above problem, embodiments of the present disclosure can provide an alternate landing position planning method for the aerial vehicle, a landing platform control method, an aerial vehicle control method, a control device, a control system, and a storage medium, which solves the technical problem of ensuring the alternate landing position to be appropriate for the safe landing of the aerial vehicle.

The method of embodiments of the present disclosure can be applied to an aerial vehicle. The aerial vehicle can include a rotor-type unmanned aerial vehicle (UAV), such as a quadcopter, hexacopter, and octocopter, a fixed-wing UAV, or a combination of the rotor-type UAV and fixed-wing UAV. The aerial vehicle can include, but is not limited to, a manned aerial vehicle, a logistic aerial vehicle, an aerial photography aerial vehicle, and an agricultural protection aerial vehicle, which is not limited in embodiments of the present disclosure.

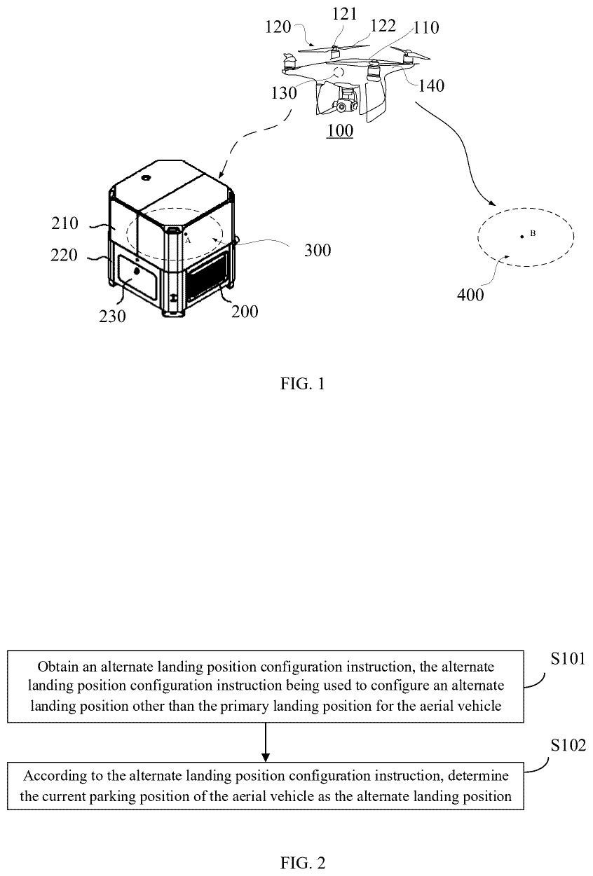

FIG. 1 is a schematic diagram showing an application scenario for an alternate landing position planning method of an aerial vehicle 100 consistent with an embodiment of the present disclosure. The application scenario includes the aerial vehicle and a landing platform 200.

The aerial vehicle 100 includes a body 110, a power system 120, a camera device, and a control device (not shown in FIG. 1). The body 110 includes a nose. In some embodiments, the aerial vehicle 100 further includes an arm 140. The arm 140 is connected to the body 110. The arm 140 is configured to mount the power system 120. In some embodiments, the power system 120 is directly mounted on the body 110. The power system 120 is configured to provide flight power for the aerial vehicle 100 and includes a motor and a propeller mounted on the motor and driven by the motor. The propeller includes a propeller base 121 and a propeller blade 122. The power system 120 drives the body 110 of the aerial vehicle 100 to rotate around one or more rotational axes.

The landing platform 200 can be configured to receive the landing aerial vehicle 100. The landing platform 200 can have different forms in different application scenarios. In some embodiments, the landing platform 200 can be a fixed platform. In other embodiments, the landing platform 200 can be a platform in any of the following application scenarios, such as a ship, car, train, and another moving platform. The landing platform 200 can include a cabin. The cabin can include a charging function and can be used as a base station. The base station can provide an accommodation space for the aerial vehicle 100 for the aerial vehicle 100 to take off and land. After the aerial vehicle 100 lands in the cabin, power charging, battery replacement, and payload replacement can be performed on the aerial vehicle 100. After the tasks are completed, the aerial vehicle 100 can take off again for group operations.

In some embodiments, the landing platform 200 can include one or more of a carrier platform 220, a cabin cover 210, and an execution mechanism. In some embodiments, the carrier platform 220 can be configured to provide a primary landing position for the aerial vehicle 100 to land. In some embodiments, the landing platform 200 can further include a pushrod assembly. The pushrod assembly can be connected to the carrier platform 220. When the pushrod assembly is opened, the pushrod assembly can push the carrier platform 220 to a preset location for the aerial vehicle 100 to take off, and when the pushrod assembly is closed, the pushrod assembly can retract the carrier platform 220 from the preset position to allow the cabin cover 210 to close. In some embodiments, the cabin cover 210 can be configured to provide an accommodation space for the aerial vehicle 100. When the cabin cover 210 is closed, the accommodation space can be at least enclosed at the top to shield the aerial vehicle 100. When the cabin cover 210 is opened, the accommodation space can be in an open state to allow the aerial vehicle 100 to fly out. In some embodiments, after the aerial vehicle 100 completes the operation, the execution mechanism can adjust the posture information and spatial occupation of the aerial vehicle 100 to accommodate the aerial vehicle 100.

In some embodiments, the landing platform 200 can also include one or more sensors, such as a positioning sensor 130, a vision sensor, a wind speed/wind direction sensor, a raindrop sensor, etc., which are configured to obtain the state information of the landing platform 200 and/or the aerial vehicle 100 parked on the landing platform 200, as well as the environmental information of the location.

Under an ideal condition, the aerial vehicle 100 can use the landing platform 200 as the return point for landing. However, in real operation scenarios, due to the complexity and variability of the operational environment, the aerial vehicle 100 may not be able to complete landing on the landing platform 200 under some abnormal conditions. Thus, if the aerial vehicle 100 continues to wait for the abnormal state to be resolved, the aerial vehicle 100 may fall directly due to a severe low battery. Alternatively, if the aerial vehicle 100 performs an emergency landing near the landing platform 200, the aerial vehicle 100 may be damaged or lost because the emergency landing position is not suitable for landing. To ensure the safe landing of the unmanned aerial vehicle (UAV), in addition to the primary landing position provided on the landing platform 200, an alternate landing position suitable for the aerial vehicle 100 to land can be planned before autonomous operations of the aerial vehicle 100. When one or more of the aerial vehicle 100, the landing platform 200, or the surrounding environment of the aerial vehicle 100 are abnormal, the aerial vehicle 100 can fly to the alternate landing position for safety.

FIG. 2 is a schematic flowchart of an alternate landing position planning method of the aerial vehicle 100 consistent with an embodiment of the present disclosure. The planning method includes S101 and S102.

At S101, an alternate landing position configuration instruction is obtained. The alternate landing position configuration instruction is used to configure an alternate landing position other than the primary landing position for the aerial vehicle 100.

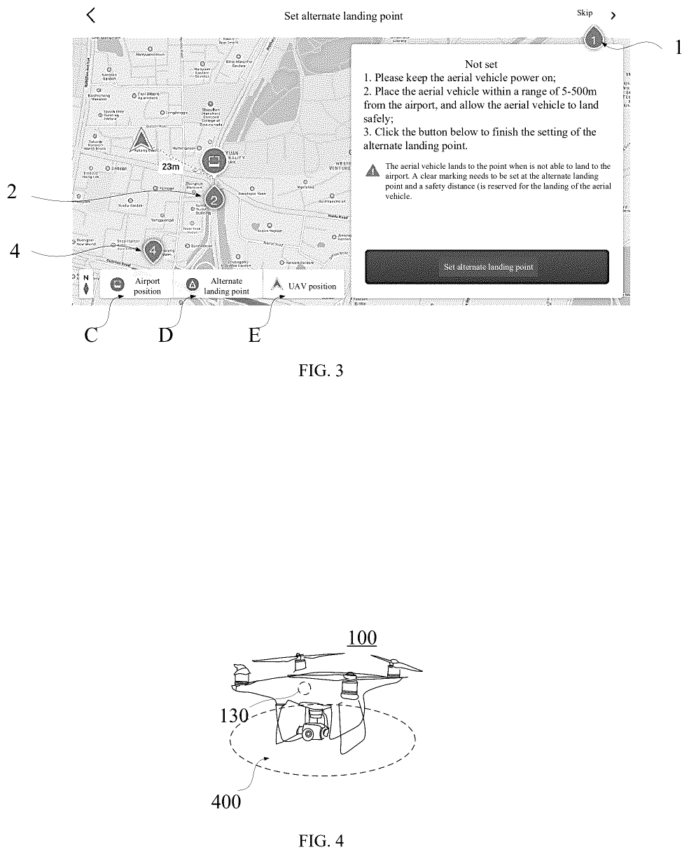

FIG. 3 is a schematic diagram of a control interface of the aerial vehicle 100 consistent with an embodiment of the present disclosure. In some embodiments, the method further includes outputting prompt information to prompt the user to place the aerial vehicle 100 in a designated area to set the alternate landing position. The designated area can be an area other than the primary landing position.

For example, the user may be prompted to place the aerial vehicle 100 in a position within 5 to 100 meters from the primary landing position where the aerial vehicle 100 can land safely. When the aerial vehicle 100 is unable to land at the primary landing position, the aerial vehicle 100 can land at the alternate landing position. In some embodiments, the method can include obtaining the distribution information of the alternate landing position around the primary landing position, and if the distribution information of the alternate landing position does not satisfy the predetermined alternate landing position distribution condition, outputting prompt information.

In some embodiments, the alternate landing position distribution condition can include that the setting position of the alternate landing position needs to satisfy a certain condition, and the set number of alternate landing position needs to satisfy a number condition. For example, the aerial vehicle 100 can remain powered on first, and the aerial vehicle 100 can be controlled to pair with the landing platform 200. After pairing, whether the alternate landing position has been configured can be detected, and the alternate landing position distribution information can be further obtained.

In some embodiments, the method can further include displaying an identifier of the current position of the aerial vehicle 100 on the control interface of the aerial vehicle 100. The alternate landing position configuration instruction can be generated based on the user confirmation operation on the control interface.

In some embodiments, the method can further include generating the alternate landing position configuration instruction based on the user confirmation operation on the control interface. For example, the control interface can be the control interface of the control terminal of the aerial vehicle 100 or the control interface of the control terminal of the landing platform 200.

In embodiments of the present disclosure, the user operation can be performed on-site using a control terminal, such as a remote controller, or remotely by the user issuing a remote operation instruction via the cloud.

As shown in FIG. 3, on the control interface of the aerial vehicle 100, for example, in the area of the identifier 4, the position C of the landing platform 200, the alternate landing position D, and the position E of the aerial vehicle 100 are displayed for guidance. On the map displayed at the upper section of the control interface, the position C of the landing platform 200, the alternate landing position D, and the position E of the aerial vehicle 100 are displayed at the current moment. Thus, the user can intuitively sense and more conveniently configure the alternate landing position. For example, when the position C of the landing platform 200 is clicked, the map can be centered at the position of the landing platform 200. When the alternate landing position D is clicked on the map, the map can be centered at the position of the landing platform 200, and the map interface can be zoomed out to display the alternate landing position D. If no alternate landing position is configured, a toast can display “no alternate landing position is configured.” When the position E of the aerial vehicle 100 is clicked on the map, the map can be centered at the position of the landing platform 200, and the map can be zoomed out to display the position E of the aerial vehicle 100. If the position of the aerial vehicle 100 does not exist, a toast can display “no position of the aerial vehicle 100 can be obtained, please move the aerial vehicle 100 to an open area.”

When the user confirms the operation on the control interface, an alternate landing position configuration instruction can be generated. For example, a prompt of “Click the button below to complete the alternate landing position configuration,” can be displayed on the control interface. The user can click the icon or confirmation control element of “configure alternate landing position” arranged below to generate the alternate landing position configuration instruction. The alternate landing position configuration instruction can be used to configure an alternate landing position for the aerial vehicle 100 in addition to the primary landing position of the aerial vehicle 100. In some embodiments, after the alternate landing position is successfully configured, the position icon E of the aerial vehicle 100 can change to the alternate landing position icon E, which is updated in the control interface. In some embodiments, a toast can display “Alternate landing position configured successfully.”

In some embodiments, before the aerial vehicle 100 begins the flight operation, user guidance information can be generated on the control interface of the aerial vehicle 100 to guide the user to configure the alternate landing position. If the alternate landing position has been configured, the configuration of the alternate landing position can be skipped. In some embodiments, when the user confirmation to skip the configuration of the alternate landing position is detected, a popup window of the control interface can prompt “if the alternate landing position is not configured, the flight task cannot be downloaded from the cloud, whether to skip the configuration of the alternate landing position?” if the user selects “Cancel,” the current control interface can remain. If the user selects “Skip,” a next process can be entered. In some embodiments, if the alternate landing position is not configured and/or updated, the alternate landing position configuration instruction can be obtained.

In some embodiments, the method can further include outputting user guidance information for configuring the alternate landing position. The user guidance information can include descriptive information of a parking position of the aerial vehicle 100 to allow the user to park the aerial vehicle 100 at a position with good landing safety according to the user guidance information to improve the efficiency of the alternate landing position configuration process. For example, the descriptive information can include one or more types of information, such as the condition description for the alternate landing position configuration, the condition description for the distance between the alternate landing position and the primary landing position, the condition description of the environment around the alternate landing position, e.g., the height or distance of the obstacle, the condition description for the flatness of the area of the alternate landing position, and the condition description for the type of the area of the alternate landing position. For example, a clear marking can be configured at the alternate landing position, and a safe landing distance can be reserved for the aerial vehicle 100. For example, the safe distance can be set to be greater than or equal to 5 m. The distance can be in the range of 5-500 m. No obvious convex or concave needs to be ensured for the ground surface. The type of the surface material of the area can be provided, and whether the area is on a movable object can be provided.

In some embodiments, the primary landing position or alternate landing position can be a position point. For example, the primary landing position can be the position point occupied when the aerial vehicle 100 is parked on the carrier platform 220 of the landing platform 200. For example, the primary landing position is a primary landing position point A shown in FIG. 1. The alternate landing position can be a position point occupied when the aerial vehicle 100 is parked at the alternate landing position. For example, the alternate landing position is an alternate landing position point B shown in FIG. 1.

In some embodiments, the primary landing position or the alternate landing position can be a position area, which can be a 2D plane or a 3D space. The size of the area can be determined according to the structure of the aerial vehicle 100 or user operation needs. For example, the primary landing position can be the area occupied by the aerial vehicle 100 on the carrier platform 220 of the landing platform 200. For example, the primary landing position is a primary landing area 300 shown in FIG. 1. The alternate landing position can be a surrounding environment area occupied when the aerial vehicle 100 is parked at the alternate landing position. For example, the alternate landing position is an alternate landing position area 400 shown in FIG. 1.

At S102, according to the alternate landing position configuration instruction, the current parking position of the aerial vehicle 100 is determined as the alternate landing position.

To configure the alternate landing position, a position suitable for the aerial vehicle 100 to land may need to be found, and the aerial vehicle 100 may need to be accurately positioned to the position to ensure the sufficient safety for the aerial vehicle 100 during the subsequent landing. For example, one solution can include recording a ground position that can be used as an alternate landing position detected during returning and landing process of the UAV. Another solution can include the user clicking the alternate landing position on the map. These two solutions can include the following scenarios. For example, after the aerial vehicle 100 has been in the flight or operation state, the aerial vehicle 100 can be forced to select the alternate landing position and land. Due to external environmental factors, sensor accuracy limitations, or low map precision, an alternate landing position suitable for the aerial vehicle 100 to land may not be guaranteed, and the positioning accuracy of the position cannot be ensured. To further improve, the map precision can be improved to improve the position precision obtained from the point selection on the map. Thus, the landing position of the aerial vehicle can be more precisely controlled.

FIG. 4 is a schematic diagram showing a scenario of determining an alternate landing position of the aerial vehicle 100 consistent with an embodiment of the present disclosure. According to the alternate landing position configuration instruction, the current parking position of the aerial vehicle 100 is determined as the alternate landing position. Thus, a pre-simulation of the future alternate landing condition can be performed before the actual flight operation to ensure that the aerial vehicle 100 can land safely at the alternate landing position. In the present disclosure, when the alternate landing position of the aerial vehicle 100 is planned, the spatial area size at the alternate landing position occupied by the aerial vehicle 100 can be pre-simulated to obtain the flatness information of the alternate landing position, the surrounding obstacle information, and collision possibility for the body 110 of and/or sensors carried by the aerial vehicle 100, to ensure that the alternate landing position is suitable for the aerial vehicle 100 to land safely.

In some embodiments, determining the current parking position of the aerial vehicle 100 as the alternate landing position can include determining the alternate landing position based on the information sensed by the positioning sensor 130 of the aerial vehicle 100 and/or the external positioning sensor 230. The external positioning sensor 230 can be arranged on the landing platform 200. The landing platform 200 can include a carrier platform 220 that provides the primary landing position.

Existing alternate landing position planning technology has the following deficiencies: inaccurate alternate landing position, complex operation, and many auxiliary devices required. In the alternate landing position planning solution for the aerial vehicle 100 of embodiments of the present disclosure, the current parking position of the aerial vehicle 100 can be determined as the alternate landing position. Thus, the operation can be simple and quick. The alternate landing position can be determined based on the information sensed by the positioning sensor 130 of the aerial vehicle 100 and/or the external positioning sensor 230. Thus, required auxiliary devices are not many, and the integration degree can be high. Even if the user does not carry an additional sensor, the alternate landing position can be configured, which reduces various operations, such as the complex device installation, calibration, and parameter configuration. Thus, the user experience can be greatly improved.

In some optional embodiments, the positioning sensor 130 of the aerial vehicle 100 and/or the external positioning sensor 230 can include, but are not limited to, any one or more of a Global Positioning System (GPS), BeiDou Navigation Satellite System (BDS), or Real-Time Kinematic (RTK) carrier phase differential positioning system. Furthermore, the configuration precision of the alternate landing position can be improved for the aerial vehicle 100 based on the centimeter-level positioning precision provided by a high precision sensor such as RTK.

In some embodiments, the landing platform 200 including the primary landing position can carry an RTK base station. A base station with a known accurate coordinate can be established. By positioning the base station by a navigation satellite, a real-time positioning coordinate of the base station can be obtained. A general positioning error can be estimated by calculating the difference between the accurate coordinate of the base station and the real-time positioning coordinate. Based on the RTK base station of the landing platform 200, the aerial vehicle 100 can carry an RTK module. In some embodiments, the RTK module can support a network RTK, a high-precision GNSS moving station, and PPK post-processing. Within a certain range with the base station as the center, the satellite positioning impact can be nearly consistent. Thus, when the base station sends the general positioning error to the aerial vehicle 100 in the range in real-time, the positioning error can be considered during the satellite positioning. Thus, the aerial vehicle 100 can be positioned in real-time, fast, and with high accuracy. In some embodiments, after the aerial vehicle 100 is paired with and connected to the landing platform 200, after the RTK states of the aerial vehicle 100 and the landing platform 200 converge, the position information of the aerial vehicle 100 can be obtained in real-time. Thus, the alternate landing position of the aerial vehicle 100 can be positioned accurately.

The base station calculates positioning errors and sends real-time corrections to aerial vehicle 100, enabling fast and high-precision real-time positioning.

To ensure the positioning accuracy, the alternate landing position can be configured directly by an additional and/or built-in positioning apparatus. However, since the size and form of the positioning apparatus are different from the size and form of the aerial vehicle 100, the position suitable for the positioning apparatus cannot be guaranteed to be suitable for the aerial vehicle 100. Thus, the landing safety of the aerial vehicle 100 cannot be guaranteed. In embodiments of the present disclosure, by determining the current parking position of the aerial vehicle 100 as the alternate landing position, the positioning accuracy at the alternate landing position can be ensured, and the alternate landing position can be ensured to be suitable for the aerial vehicle 100 to land safely.

In some embodiments, the method can further include obtaining the position of the aerial vehicle 100, obtaining the configured alternate landing position around the primary landing position, and when the position of the aerial vehicle 100 is detected to be different from the alternate landing position, and an alternate landing position update instruction is received, determining the position of the aerial vehicle 100 as the updated alternate landing position.

In some embodiments, the method can further include selecting the configured alternate landing position around the primary landing position based on the user selection operation, obtaining another alternate landing position in addition to the configured alternate landing position, and in response to receiving the alternate landing position update instruction, updating the configured alternate landing position as the another alternate landing position.

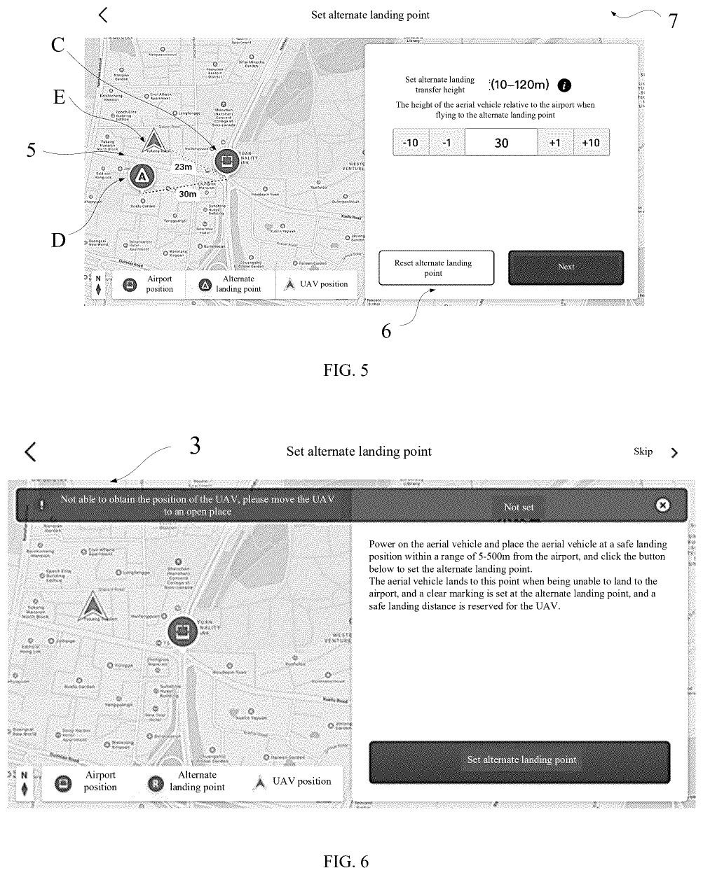

FIG. 5 is a schematic diagram of another control interface of the aerial vehicle 100 consistent with an embodiment of the present disclosure. In an area of a marking 5, an identifier representing that the alternate landing position has been configured around the primary landing position is displayed. The user can move the position of the aerial vehicle 100. When the aerial vehicle 100 is not at the same position as the alternate landing position, a map interface can be displayed on the control interface of the aerial vehicle 100. The identifier representing that the alternate landing position has been configured around the primary landing position can be displayed on the map interface. In some embodiments, the current position of the aerial vehicle 100 can also be displayed. In some embodiments, a confirmation control element for the alternate landing position update can also be displayed. When the confirmation control element is detected to be clicked by the user, e.g., the user is detected to point-contact the confirmation icon “re-configure alternate landing point” in the area of the marking 6, the position of the aerial vehicle 100 can be determined as the updated alternate landing position.

In some embodiments, the user can proactively update the alternate landing position. In some embodiments, due to the change in the actual environment, the previously configured alternate landing position may not be suitable as an alternate landing position for the aerial vehicle 100 under the current environment. In the area of the marking 7, the key “skip” can be hidden.

In some embodiments, the user can land the aerial vehicle 100 at a designed area manually or automatically. In some embodiments, before determining the current parking position of the aerial vehicle 100 as the alternate landing position, the method can further include controlling the aerial vehicle 100 to take off from the primary landing position and controlling the aerial vehicle 100 to land at the designated landing area.

In some embodiments, the designated landing area can be determined based on the joystick control operation of the user on the remote controller of the aerial vehicle 100.

In some embodiments, the designated landing area can be determined based on an area selection operation of the user on the control interface of the remote controller of the aerial vehicle 100.

In some embodiments, the area selection operation on the control interface can include selecting a landing area from an environment image collected by the aerial vehicle 100 and/or selecting the landing area in the map interface associated with the geographic position of the aerial vehicle 100.

In some embodiments, selecting the landing area from the environment image collected by the aerial vehicle 100 can include identifying a to-be-selected landing area (also referred to as a “candidate landing area”) from the environment image according to a preset landing area identification model, displaying the push identifier of the to-be-selected landing area on the control interface, determining the to-be-selected landing area as the designated landing area based on the selection operation of the user on the marked control interface, and controlling the aerial vehicle 100 to land in the designated landing area. Selecting the landing area from the environment image collected by the aerial vehicle 100 can further include based on a box-selection operation of the user on the environment image, using the box-selected area of the user as the designated landing area, and controlling the aerial vehicle 100 to land in the designated landing area.

As shown in FIG. 5, in some embodiments, the method further includes displaying one or more pieces of information on the display interface, such as an alternate landing position identifier, a primary landing position identifier, a position identifier of the aerial vehicle 100, a position identifier of the alternate landing position, the position information of the primary landing position, the position information of the position of the aerial vehicle 100, and the relative position relationship information. The relative position relationship information can include the relative position relationship information between any two of the alternate landing position, the primary landing position, the position of the aerial vehicle 100. For example, the relative position and the distance between the alternate landing position D and the primary landing position C can be displayed in the area of the marking 5. Meanwhile, the relative position and the distance between the position E of the aerial vehicle 100 and the primary landing position C. In some embodiments, two connection lines of different colors can be used for distinguishment. In some embodiments, with the primary landing position as the center, the surrounding map can be displayed. With the ratio of the map, the position of the aerial vehicle 100 and the alternate landing position can be displayed. If the position of the aerial vehicle 100 and the alternate landing position are not provided, or the aerial vehicle 100 and the alternate landing position are close to the primary landing position, an appropriate ratio can be provided. Through the connection line between the position of the aerial vehicle 100 and the primary landing position, the relative position relationship can be displayed. Through the intuitive interface information, the user can conveniently check whether the configuration of the alternate landing position satisfies the preset environment condition surround the alternate landing position, e.g., the distance, flatness information, and empty level information of the alternate landing position relative to the primary landing position. Thus, the user can conveniently configure or adjust the alternate landing position to ensure landing safety.

In some embodiments, the method can further include obtaining the state information of the aerial vehicle 100 at the parking position, and when the state information of the aerial vehicle 100 does not satisfy the preset state condition, generating the prompt information indicating that the alternate landing position is abnormally configured.

In some embodiments, the state information can include one or more of the distance information of the parking position relative to the primary landing position, the tilt information of the aerial vehicle 100, and the obstacle distribution information of the surrounding environment of the aerial vehicle 100.

FIG. 6 is a schematic diagram showing another control interface of the aerial vehicle 100 consistent with an embodiment of the present disclosure. By prompting the abnormal information, the user can conveniently detect the reason for the configuration failure of the alternate landing position, and reliable guidance can be provided for re-configuring the alternate landing position. For example, the aerial vehicle 100 can be prompted with “not configured” for the alternate landing position in the control interface. In some embodiments, the following guidance can be generated, such as, “Please power on the aerial vehicle 100, place the aerial vehicle 100 in the range within 5-500 m from the airport, and use the button below the motor to configure the alternate landing position. When the aerial vehicle 100 cannot land at the airport, land the aerial vehicle 100 at the alternate landing position, provide a clear identifier at the alternate landing position, and reserve a landing safety distance for the aerial vehicle 100.” In some embodiments, when the state information of the aerial vehicle 100 does not satisfy the preset state condition, the configuration of the alternate landing position fails. In the area of the marking 3, prompt information indicating that the configuration of the alternate landing position is abnormal can be displayed by downward sliding. By clicking the “x” mark at the right corner of the interface, the prompt information can disappear. In some embodiments, the preset prompt information can include one or more of “the alternate landing position being too close to/far away from the primary landing position, please move the aerial vehicle 100 and configure the alternate landing position again; please maintain the aerial vehicle 100 on; the position of the aerial vehicle 100 cannot be obtained, please move the aerial vehicle 100 to the empty area; the RTK positioning of the aerial vehicle 100 not converging, please wait until the RTK positioning of the aerial vehicle 100 converge then reconfigure the alternate landing position; and obtain the GPS position of the aerial vehicle 100, however, the aerial vehicle 100 does not converge to RTK.”

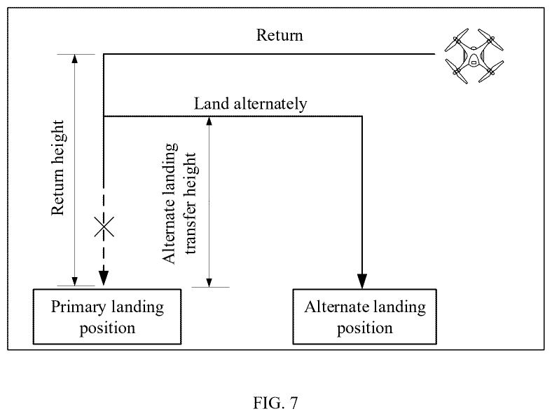

In some embodiments, the method can further include obtaining a height parameter configuration instruction. The height parameter can be used to adjust the flight point height of the flight trajectory when the aerial vehicle 100 flies to the alternate landing position. For example, FIG. 7 is a schematic diagram of setting the height parameter consistent with an embodiment of the present disclosure. When the aerial vehicle 100 returns normally, the height of the return flight is configured to the primary landing position. When the aerial vehicle 100 cannot land at the primary landing position normally, the transfer height can be set to the alternate landing position.

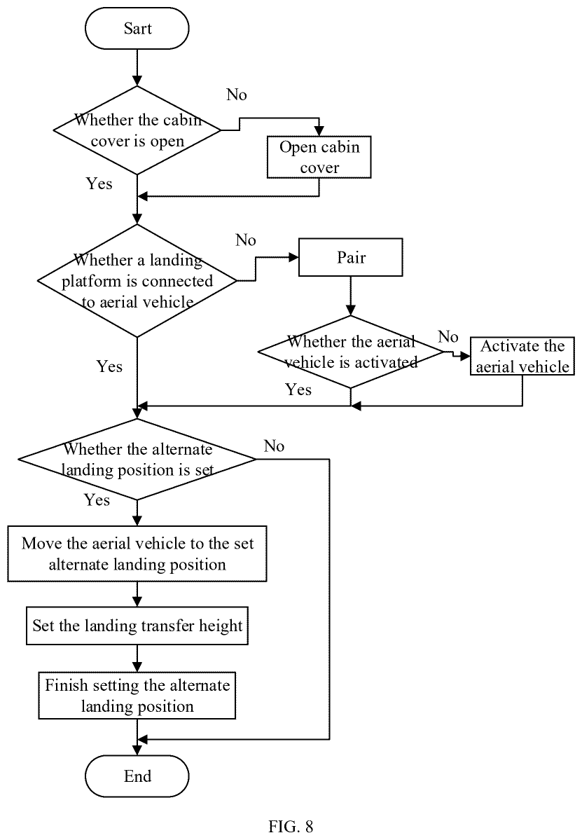

FIG. 8 is a schematic flowchart of planning the alternate landing position of the aerial vehicle 100 consistent with an embodiment of the present disclosure. In some embodiments, the remote controller can be connected to the landing platform through a USB cable. In some embodiments, whether the cabin cover 210 is open can be detected. If the cabin cover 210 is not open, the user can be prompted to click on the remote controller to open the cabin cover 210. In some embodiments, after the cabin cover 210 is open, whether the aerial vehicle and the airport are paired can be detected. If the aerial vehicle and the airport are not paired, whether the aerial vehicle is activated can be detected. The aerial vehicle can be activated first, and the aerial vehicle can be then paired with the airport. In some embodiments, it can wait for the states of the landing platform 200 and the RTK of the aerial vehicle 100 to converge. In some embodiments, whether the alternate landing position has been configured can be detected. If the alternate landing position has been configured, the configuration of the alternate landing position can be skipped. In some embodiments, if the alternate landing position needs to be configured or updated, the user can be prompted to move the aerial vehicle 100 from the landing platform 200 to the designated position. In some embodiments, the alternate landing position configuration instruction can be obtained. The alternate landing position configuration instruction can be used to configure another alternate landing position in addition to the primary landing position of the aerial vehicle 100. According to the alternate landing position configuration instruction, the current parking position of the aerial vehicle 100 can be determined as the alternate landing position. In some embodiments, when the state information of the aerial vehicle 100 does not satisfy the preset state condition, the configuration of the alternate landing position can fail. The prompt information of indicating that the configuration of the alternate landing position is abnormal, such as, the alternate landing position should be within the range of 2000-30 m from the primary landing position without a shielding object, and a clear identifier is provided. In some embodiments, the landing transfer height can be configured to range from 10 to 500 m to complete the configuration of the alternate landing position of the aerial vehicle 100.

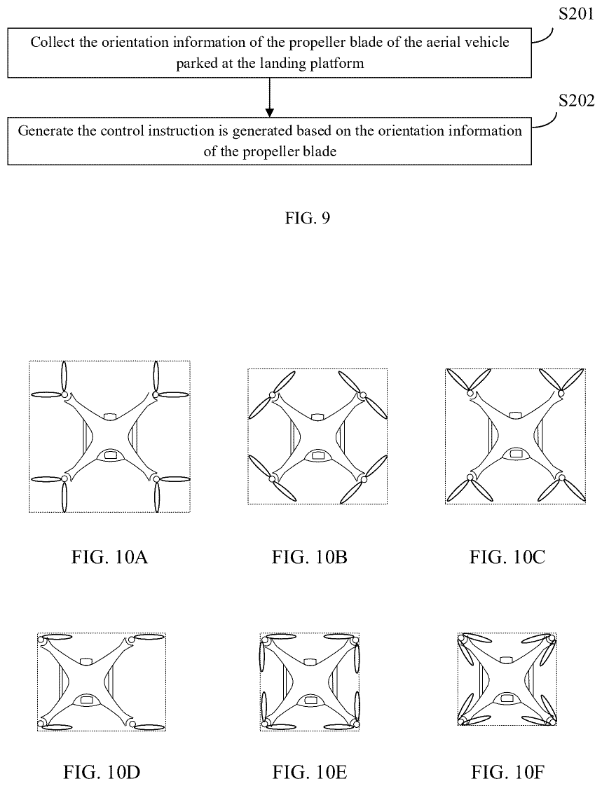

FIG. 9 is a schematic flowchart of a landing platform control method consistent with an embodiment of the present disclosure. The control method includes S201 and S202.

At S201, the orientation information of the propeller blade 122 of the aerial vehicle 100 parked at the landing platform 200 is collected.

In some embodiments, collecting the orientation information of the propeller blade 122 of the aerial vehicle 100 parked at the landing platform 200 can include collecting the image of the propeller blade 122 during the rotation of the propeller 122, and determining the orientation information of the propeller blade 122 according to the imaging position of the propeller 122 in the image.

In some embodiments, the landing platform 200 can include a sensor. The sensor can be provided at the cabin cover 210.

When the cabin cover 210 is open, the sensor can face the parking area carrying the aerial vehicle 100 to obtain the image of the propeller blade 122 of the aerial vehicle 100. When the cabin cover 210 is shielded, the sensor can be configured to monitor the environment information surrounding the landing platform 200.

In some embodiments, the sensor can be a recording apparatus of the landing platform 200. The recording apparatus can be used as the position sensor for the propeller blade 122 of the aerial vehicle 100. The recording apparatus can be configured to capture an image of the propeller blade 122 of the aerial vehicle 100. Image identification can be performed on the obtained image to analyze the orientation of the propeller blade 122. The obtained orientation information of the propeller blade 122 can be continuously transmitted to the aerial vehicle 100.

In some embodiments, collecting the orientation information of the propeller blade 122 of the aerial vehicle 100 parked on the landing platform 200 can include collecting the orientation information of the propeller blade 122 through the sensor of the aerial vehicle 100 and/or the sensor carried by the landing platform 200.

In some embodiments, the control method for the landing platform 200 can include, collecting the image of the propeller blade 122 when the propeller blade 122 of the aerial vehicle 100 rotates, determining the orientation of the propeller blade 122 according to the imaging position of the propeller blade 122 in the image, and stopping the rotation of the propeller blade 122 when the orientation of the propeller blade 122 in the preset position.

At S202, the control instruction is generated based on the orientation information of the propeller blade 122. The control instruction is used to control the propeller blade 122 to stop rotating in the preset area.

Existing motor control of an aerial vehicle only includes the rotation speed control without the rotation angle control. That is, the motor or the propeller blade 122 of the aerial vehicle 100 cannot stop at a certain orientation. Thus, when the propeller blade 122 of the aerial vehicle 100 stops rotating, the orientation of the propeller blade 122 can be random and uncontrollable. Since the landing platform 200 needs to accommodate the landed aerial vehicle 100, the storage space or accommodation cabin of the landing platform 200 needs to be large, or an additional accommodation structure may be needed.

In embodiments of the present disclosure, the propeller blade 122 of the aerial vehicle 100 parked at the landing platform 200 can be controlled to stop rotation in the preset area. When the propeller blade 122 stops rotation, the propeller blade 122 can stop at the certain orientation to save the storage space when the storage space of the landing platform 200 is limited, which is beneficial for the miniaturization of the landing platform 200. Thus, the landing platform 200 can be applied in a broad application scenario.

Scenarios with four propeller blades 122 are described below as an example, but the number of the propeller blades 122 is not limited in the present disclosure. FIG. 10A is a schematic diagram showing an orientation of the propeller blades 122 being not in a preset area consistent with an embodiment of the present disclosure. FIG. 10B to FIG. 10F are schematic diagrams showing different types of the propeller blades 122 being in a preset area consistent with an embodiment of the present disclosure. As shown in FIG. 10A, after the aerial vehicle lands at the landing platform 200, if the orientation of the propeller blades 122 is not controlled, the orientation of the propeller blades 122 of the aerial vehicle 100 is not in the preset area, and the size of the storage space of the landing platform 200 needed for accommodating the aerial vehicle 100 can be represented at least by the dashed box. As shown in FIG. 10B to FIG. 10F, the propeller blades 122 stop rotation in the preset area, and the size of the storage space of the landing platform 200 needed for accommodating the aerial vehicle 100 is represented at least by the dashed box. Compared to the dashed box shown in FIG. 10A, in the control solution for accommodating the propeller blades in FIG. 10B to FIG. 10F, the storage space is saved, the volume needed for the landing platform 200 is reduced, and the cost is saved.

In some embodiments, the landing platform can also include a block member. The aerial vehicle can include a plurality of propeller blades. The method can include controlling the block member to be close to the propeller blades to block the movement of the first propeller blade of the aerial vehicle to allow the first propeller blade to rotate with other propeller blades to reduce the angle between the first propeller blade and the other propeller blades. The other propeller blades can be propeller blades of the plurality of propeller blades except for the first propeller blade. In some embodiments, after the block member blocks the movement of the first propeller blade, the block member can stop moving, and the first propeller blade can stop rotating. In some embodiments, after the block member blocks the movement of the first propeller blade, the block member can continue to move to drive the first propeller blade to continue to move. Thus, the angle between the first propeller blade and the other propeller blades can be further reduced.

In some embodiments, the method can further include, if the position relationship between the first propeller blade and the other propeller blades satisfies the preset condition, e.g., smaller than 90°, controlling the other propeller blades to stop rotating. In some embodiments, according to the form of the landing platform, the corresponding condition can be preset to allow the position of the propeller blade of the aerial vehicle to cooperate to allow the landing platform to close the cabin cover.

In some embodiments, the rotation of the other propeller blades can include the rotation driven by the motor and/or the rotation due to the external force applied by the execution mechanism of the landing platform.

In some embodiments, the control instruction can be generated based on the orientation information of the propeller blade. The control instruction can be used to control the propeller blade to stop rotating in the preset area. If the position relationship between the first propeller blade and the other propeller blades satisfies the preset condition, the plurality of propeller blades can be controlled to move to the preset area and stop rotating based on the control instruction.

In some embodiments, controlling the plurality of propeller blades to move to the preset area and stop rotating based on the control instruction can include driving the plurality of propeller blades to rotate based on the motor and/or rotating due to the external force applied to the propeller blades based on the execution mechanism of the landing platform.

For example, the execution mechanism and/or the block member of the landing platform can be the cabin cover of the landing platform, an assembly connected to the cabin cover of the landing platform, or another assembly connected to the landing platform.

In some embodiments, the method can further include controlling the cabin cover 210 of the landing platform 200 to move to shield the aerial vehicle 100 to prevent the aerial vehicle 100 from being exposed to the outside when no personnel monitors and avoid the damages made to the aerial vehicle 100 due to weather or human factors. In some embodiments, the movement of the cabin cover 210 of the landing platform 200 can be adjusted according to the time needed for controlling the aerial vehicle 100 to stop rotating in the preset area to allow the landing platform 200 to accommodate the aerial vehicle 100 in time.

In some embodiments, the aerial vehicle 100 can include a body 110, an arm 140, and a propeller base 121. A plurality of arms 140 extending from the body 110 to support a plurality of propeller bases 121. The propeller blades 122 can be arranged at the propeller base 121. The preset area can be a polygon. Any angle point of the polygon can be at the position of the propeller base 121. As shown in FIG. 10E or 10F, the propeller blades 122 of the aerial vehicle 100 stop in the preset area. The volume of the storage space occupied by the aerial vehicle 100 can be further reduced, which is beneficial for the miniaturization of the landing platform 200.

In some embodiments, the method can further include, when the propeller blade 122 is not in the preset area, performing one or more of the following operations to cause the propeller blade 122 to be in the preset area. The following operations can include controlling the propeller blade 122 to rotate again, and generating the control instruction again based on the orientation information of the propeller blade, or controlling the execution apparatus of the landing platform 200 to push the propeller blade 122.

Due to the abnormality or large error, after the propeller blade 122 stops rotating, the orientation of the propeller blade 122 may not satisfy the preset condition. In some embodiments, after controlling the propeller blade 122 to rotate again, S201 and S202 can be performed again. In some embodiments, the execution apparatus of the landing platform 200, e.g., the execution mechanism of the cabin cover 210, can be configured to push the propeller blade 122 to eventually reach the preset area to complete the accommodation for the aerial vehicle 100.

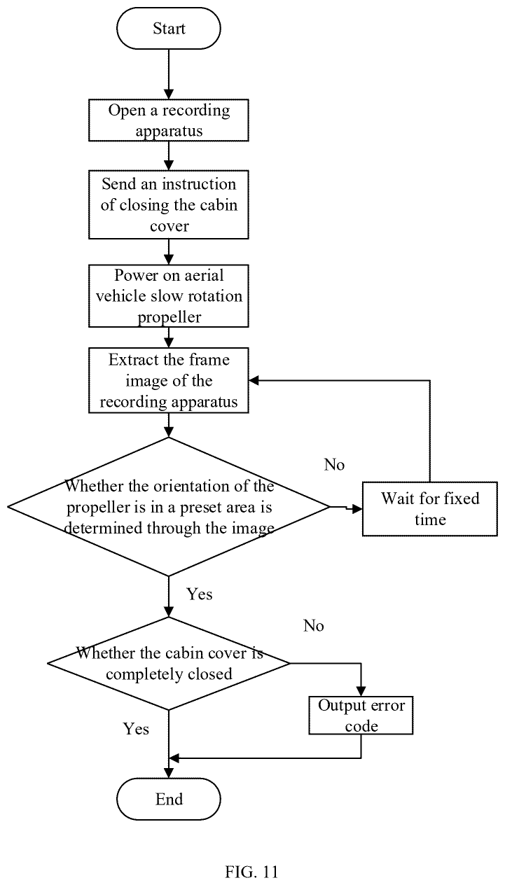

FIG. 11 is a schematic flowchart of a landing platform control method consistent with an embodiment of the present disclosure. The recording apparatus of the landing platform 200 is powered on, and the instruction of closing the cabin cover 210 is issued, and a slow rotation propeller of the aerial vehicle 100 is powered on. The slow rotation propeller can be an operation mode of another rotation propeller blade of the aerial vehicle. After the aerial vehicle has been parked at the landing platform, the aerial vehicle can start the slow propeller operation mode to allow the propeller blade of the aerial vehicle to rotate slowly. Thus, the parking orientation of the propeller blade can be conveniently controlled to avoid the situation that the propeller blade cannot be positioned and/or the parking orientation of the propeller blade cannot be accurately controlled when the propeller blade rotates too fast. The frame image of the recording apparatus can be extracted. Whether the orientation of the propeller blade 122 is in the preset area can be determined. If the propeller blade 122 is not in the preset area, wait for fixed time, e.g., 100 ms, the frame image of the recording apparatus can be extracted. If the aerial vehicle 100 is in the preset area, whether the cabin cover 210 of the landing platform 200 is closed can be detected. If the cabin cover 210 is not closed, prompt information of an error code can be outputted. If the cabin cover 210 is closed, the control process can be ended.

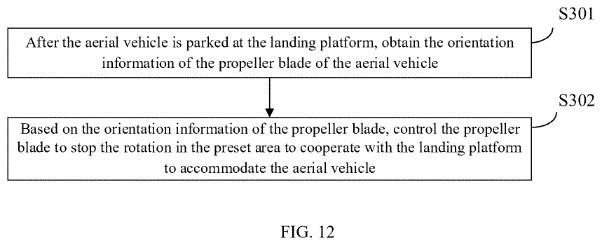

FIG. 12 is a schematic flowchart of a control method of the aerial vehicle 100 consistent with an embodiment of the present disclosure. The control method includes process S301 and process S302.

At S301, after the aerial vehicle 100 is parked at the landing platform 200, the orientation information of the propeller blade 122 of the aerial vehicle 100 is obtained.

In some embodiments, obtaining the orientation information of the propeller blade 122 of the aerial vehicle 100 can include obtaining the image of the propeller blade 122 during the rotation of the propeller blade 122, and determining the orientation information of the propeller blade 122 according to the imaging position of the propeller blade 122 in the image.

In some embodiments, obtaining the orientation information of the propeller blade 122 of the aerial vehicle 100 can include obtaining the orientation information of the propeller blade 122 through the sensor carried by the landing platform 200.

In some embodiments, another device, e.g., a cell phone, or another aerial vehicle, can be configured to obtain the orientation information of the propeller blade 122 of the aerial vehicle 100 and send the orientation information to the aerial vehicle 100 parked at the landing platform 200.

At S302, based on the orientation information of the propeller blade 122, the propeller blade 122 is controlled to stop rotating in the preset area to cooperate with the landing platform 200 to accommodate the aerial vehicle 100.

For the description of the preset area, reference can be made to the description of FIGS. 10A to 10F. In embodiments of the present disclosure, the propeller blade 122 of the aerial vehicle 100 parked at the landing platform 200 can be controlled to stop rotating in the preset area, which is beneficial for the miniaturization of the landing platform 200 that accommodates the aerial vehicle 100. Thus, the landing platform 200 can be applied in a broader scenario.

In some embodiments, the landing platform can further include the block member. The aerial vehicle can include the plurality of propeller blades. The method can further include, if the moving position of the first propeller blade of the plurality of propeller blades is blocked by the block member, controlling the other propeller blades to continue to rotate to cause the angle between the first propeller blade and the other propeller blades to reduce. The other propeller blades can be propeller blades of the plurality of propeller blades except for the first propeller blade. In some embodiments, after the block member blocks the movement of the first propeller blade, the block member can stop moving, and the first propeller blade can stop rotating. In some embodiments, after the block member blocks the first propeller blade from moving, the block member can continue to move to drive the first propeller blade to continue to move to cause the angle between the first propeller blade and the other propeller blades to be further reduced.

In some embodiments, the method can further include, if the position relationship between the first propeller blade and the other propeller blades satisfies the preset condition, e.g., the angle smaller than 90°, controlling the other propeller blades to stop rotating. In some embodiments, the corresponding condition can be preset according to the form of the landing platform to cause the position of the propeller blade of the aerial vehicle to cooperate with the landing platform to close the cabin cover.

In some embodiments, the position relationship between the first propeller blade and the other propeller blades satisfying the preset condition can include the position relationship between the first propeller blade and the other propeller blades obtained based on the image detection satisfying the preset condition and/or the position relationship between the first propeller blade and the other propeller blades obtained based on the mapping of the motor stall current.

In some embodiments, the rotation of the other propeller blades can include rotation driven by the motor and/or rotation due to the external force applied by the execution mechanism of the landing platform.

In some embodiments, generating the control instruction based on the orientation information of the propeller blade, the control instruction being used to control the propeller blade to stop rotating in the preset area, can include, if the position relationship between the first propeller blade and the other propeller blades satisfies the preset condition, controlling the plurality of propeller blades to move to the preset area and stop rotating based on the control instruction.

In some embodiments, controlling the plurality of propeller blades to move to the preset area and stop rotating based on the control instruction can include driving the plurality of propeller blades to rotate based on the motor and/or applying the external force to the propeller blade based on the execution mechanism of the landing platform to cause the propeller blade to rotate.

For example, the execution mechanism of the landing platform and/or the block member can be the cabin cover of the landing platform, the assembly connected to the cabin cover of the landing platform, or another assembly connected to the landing platform.

As shown in FIG. 10E or FIG. 10F, in some embodiments, the aerial vehicle 100 includes the body 110, the arm 140, and the propeller base 121. The plurality of arms 140 extend from the body 110 to support the plurality of propeller bases 121. The propeller blades 122 are arranged at the propeller base 121. The preset area can be a polygon. Any angle point of the polygon can be at the position of the propeller base 121.

In some embodiments, the method can further include, when the propeller blade 122 is not in the preset area after the propeller blade 122 stops rotating, controlling the propeller blade 122 to rotate again to cause the propeller blade 122 to be in the preset area.

In some embodiments, the landing platform 200 can include a camera module of the UAV configured to collect the image of the four propeller blades 122 of the UAV. In some embodiments, the landing platform 200 can include an image processing system for processing the camera data, performing image identification according to the obtained image to analyze the angle of the propeller blade 122 to obtain the orientation information of the propeller blade 122. In some embodiments, the landing platform 200 can include a communication module between the aerial vehicle 100 configured to continuously transmit the obtained angle information of the propeller blade 122 to the aerial vehicle 100 in real-time. In some embodiments, the aerial vehicle 100 can include a flight control module configured to control the drive module of the motor. In some embodiments, the aerial vehicle 100 can include the motor control module configured to control the rotation of the motor. In some embodiments, after receiving the orientation information of the propeller blade 122, according to the target angle, the flight control module can be configured to calculate the deviation to control the rotation speed of the propeller blade 122. When the deviation is in a certain error range, the motor drive module can be controlled to control the propeller blade 122 to stop rotating.

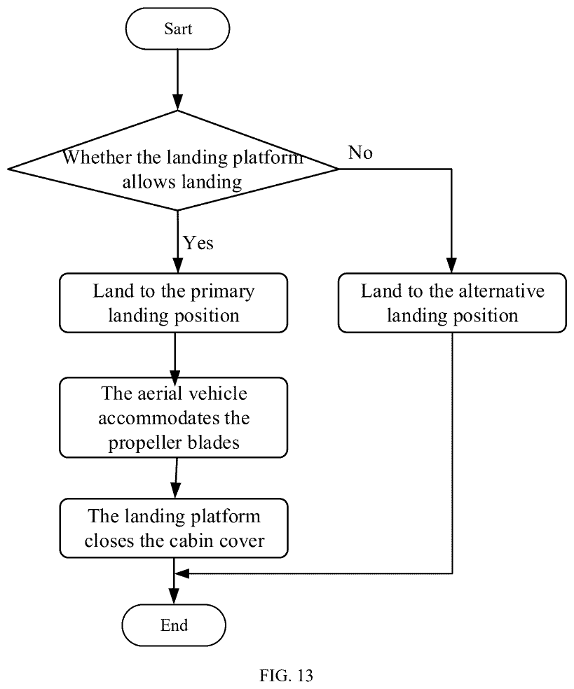

FIG. 13 is a schematic flowchart of a landing method of the aerial vehicle 100 consistent with an embodiment of the present disclosure. Whether the landing platform 200 allows landing is determined. If the landing platform 200 allows landing, the aerial vehicle 100 lands at the primary landing position, the aerial vehicle 100 accommodates the propeller blade 122, and the cabin cover 210 of the landing platform 200 is closed. If the landing platform 200 does not allow landing, the aerial vehicle 100 can land at the alternate landing position configured in the alternate landing position planning method of the aerial vehicle 100.

In some embodiments, the aerial vehicle 100 can normally land at the landing platform 200. By accommodating the propeller blade 122 of the aerial vehicle 100, i.e., the propeller blade 122 can be controlled to stop rotating in the preset area based on the orientation information of the propeller blade 122, and the cabin cover 210 of the landing platform 200 can be closed to accommodate the aerial vehicle 100. Thus, when the storage space of the landing platform 200 is limited, the storage space can be saved, which is beneficial for the miniaturization of the landing platform 200. Thus, the landing platform 200 can be applied in a broader application scenario.

In embodiments of the present disclosure, before the aerial vehicle 100 automatically performs the operation, the alternate landing position suitable for the aerial vehicle 100 to land can be planned. When one or more of the aerial vehicle 100, the landing platform 200, and the surrounding environment of the aerial vehicle 100 are abnormal, the aerial vehicle 100 can fly to the alternate landing position to ensure the landing safety.

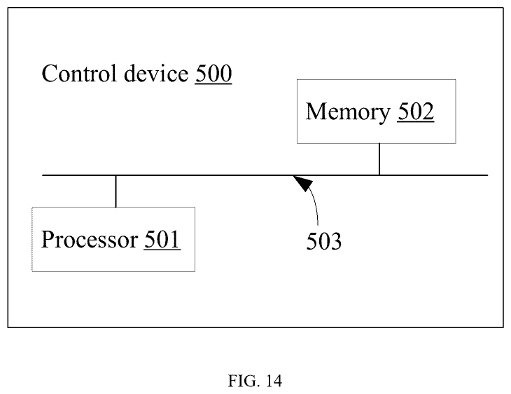

FIG. 14 is a schematic structural diagram of a control device 500 consistent with an embodiment of the present disclosure. The control device 500 is applied to the aerial vehicle or the landing platform 200. The control device can be integrated into the aerial vehicle 100 or the landing platform 200. The control device can be configured independently of the aerial vehicle 100 or the landing platform 200 and can be communicatively connected to the aerial vehicle 100 or the landing platform 200. The method can also be applied to the control device 500. For example, the control device can be the control terminal of the aerial vehicle 100 or the control terminal of the landing platform 200.

As shown in FIG. 14, the control device 500 includes a processor 501 and a memory 502. The processor 501 and the memory 502 are connected through a bus 503. The bus 503 can include an I2C (Inter-integrated Circuit) bus.

In some embodiments, the processor 501 can be a microcontroller unit (MCU), a central processing unit (CPU), a digital signal processor (DSP), etc.

In some embodiments, the memory 502 can be a Flash chip, a read-only memory (ROM), a magnetic disk, an optical disk, a USB flash drive, a mobile hard drive, etc.

The processor 501 can be configured to run the computer program stored in the memory 502 and implement the processes of the control method of the aerial vehicle 100 when executing the computer program.

Exemplarily, the processor 501 can be configured to run the computer program stored in the memory 502 to obtain the alternate landing position configuration instruction, the alternate landing position configuration instruction being used for configuring another alternate landing position other than the primary landing position of the aerial vehicle 100, and determining the current parking position of the aerial vehicle 100 as the alternate landing position according to the alternate landing position configuration instruction.

In some embodiments, determining the current parking position of the aerial vehicle 100 as the alternate landing position can include determining the alternate landing position based on the information sensed by the positioning sensor 130 of the aerial vehicle 100 and/or the external positioning sensor 230. The external positioning sensor 230 can be arranged on the landing platform 200. The landing platform 200 can include a carrier platform 220 configured to provide the primary landing position.

In some embodiments, the processor 501 can also be configured to output the prompt information to prompt the user to place the aerial vehicle 100 in the designated area to configure the alternate landing position.

In some embodiments, the processor 501 can also be configured to obtain the distribution information of the alternate landing positions around the primary landing position, and if the distribution information of the alternate landing positions does not meet the preset alternate landing position distribution condition, output the prompt information.

In some embodiments, the processor 501 can also be configured to display an identifier of the current position of the aerial vehicle 100 on the control interface of the aerial vehicle 100.

In some embodiments, the processor 501 can be also configured to generate the alternate landing position configuration instruction based on the user confirmation operation on the control interface. Exemplarily, the control interface can be the control interface of the control terminal of the aerial vehicle 100, or the control interface of the control terminal of the landing platform 200.

In some embodiments, the processor 501 can also be configured to obtain the position of the aerial vehicle 100, obtain the configured alternate landing positions around the primary landing position, and determine the position of the aerial vehicle 100 as the updated alternate landing position when the position of the aerial vehicle 100 is detected to be different from the alternate landing position and the alternate landing position update instruction is received.

In some embodiments, the processor 501 can also be configured to select a configured alternate landing position around the primary landing position based on the user selection operation, obtain another alternate landing position other than the configured alternate landing position, and in response to receiving the alternate landing position update instruction, update the configured alternate landing position to the another alternate landing position.

In some embodiments, the processor 501 can be also configured to output the user guidance information for the alternate landing position. The user guidance information can include descriptive information on the parking position of the aerial vehicle 100.

In some embodiments, before determining the current parking position of the aerial vehicle 100 as the alternate landing position, the processor 501 can also be configured to control the aerial vehicle 100 to take off from the primary landing position and control the aerial vehicle 100 to land in the designated area.

In some embodiments, the designated landing area can be determined based on the user control of the joystick of the remote controller of the aerial vehicle 100.

In some embodiments, the designated landing area can be determined based on the user area selection operation on the control interface of the aerial vehicle 100.

In some embodiments, the area selection operation on the control interface can include selecting the landing area in the environmental image collected by the aerial vehicle 100 and/or selecting the landing area on the map interface associated with the geographic position of the aerial vehicle 100.

In some embodiments, the processor 501 can also be configured to display one or more pieces of the following information on the display interface, such as the identifier of the alternate landing position, the identifier of the primary landing position, the identifier of the position of the aerial vehicle 100, the position information of the alternate landing position, the position information of the primary landing position, the position information of the position of the aerial vehicle 100, and the relative position relationship.

The relative position relationship can include the relative position relationship information between positions of any two of the alternate landing position, the primary landing position, and the position of the aerial vehicle 100.

In some embodiments, the processor 501 can also be configured to obtain the state information of the aerial vehicle 100 when parked, and when the state information of the aerial vehicle 100 does not meet the preset state condition, generate the prompt information indicating that that the configuration of the alternate landing position is abnormal.

In some embodiments, the state information can include one or more of the distance information of the parking position relative to the primary landing position, the tilted information of the aerial vehicle 100, and the obstacle distribution information in the surrounding environment of the aerial vehicle 100.

In some embodiments, the processor 501 can also be configured to obtain the height parameter configuration instruction. The height parameter can be used to adjust the height of the waypoint of the flight trajectory of the aerial vehicle 100 when heading to the alternate landing position.

Exemplarily, the processor 501 can be configured to run the computer program stored in the memory 502 to collect the orientation information of the propeller blade 122 of the aerial vehicle 100 parked on the landing platform 200, and generate a control instruction based on the orientation information of the propeller blade 122. The control instruction can be used to control the propeller blade 122 to stop rotating in the preset area.

In some embodiments, the landing platform can further include the blocking member. The aerial vehicle 100 can include the plurality of propeller blades. The processor can also be configured to control the blocking member to approach the propeller blade to block the movement of the first propeller blade of the aerial vehicle to reduce the angle between the first propeller blade and the other propeller blades with the rotation of the other propeller blades. The other propeller blades can be the propeller blades of the plurality of propeller blades except for the first propeller blade.

In some embodiments, the processor can be further configured to, if the position relationship between the first propeller blade and the other propeller blades satisfies the preset condition, control the other propeller blades to stop rotating.

In some embodiments, the rotation of the other blades can include the rotation driven by the motor and/or the rotation due to the external force applied by the execution mechanism of the landing platform.

In some embodiments, generating the control instruction based on the orientation information of the propeller blade, the control instruction being used to control the propeller blades to stop rotating within the preset area, can include, if the position relationship between the first propeller blade and the other propeller blades meets the preset condition, controlling the plurality of propeller blades to move to the preset area and stop rotating based on the control instruction.

In some embodiments, controlling the plurality of propeller blades to move to the preset area and stop rotating based on the control instruction can include driving the plurality of propeller blades to rotate based on the motor and/or applying the external force to the propeller blades based on the execution mechanism of the landing platform to cause the propeller blades to rotate.

Exemplarily, the execution mechanism and/or block member of the landing platform can be the cabin cover of the landing platform, the assembly connected to the cabin cover of the landing platform, or another assembly connected to the landing platform.

In some embodiments, the processor 501 can also be configured to control the movement of the cabin cover 210 of the landing platform 200 to shield the aerial vehicle 100.

In some embodiments, the aerial vehicle 100 can include the body 110, the arm 140, and the propeller base 121. The plurality of arms 140 can extend from the body 110 to support the plurality of propeller bases 121. The propeller blades 122 can be arranged at the propeller base 121. The preset area can be a polygon. Any angle point of the polygon can be at the position of the propeller base 121.

In some embodiments, collecting the orientation information of the propeller blade 122 of the aerial vehicle 100 parked on the landing platform 200 can include collecting the image of the propeller blades 122 during the rotation process of the propeller blades 122 and determining the orientation information of the propeller blades 122 according to the imaging position of the propeller blades 122 in the image.

In some embodiments, the landing platform 200 can include a sensor. The sensor can be arranged at the cabin cover 210. When the cabin cover 210 is open, the sensor can face the parking area carrying the aerial vehicle 100 to obtain the image of the propeller blade 122 of the aerial vehicle 100. When the cabin cover 210 is shielded, the sensor can be configured to monitor the environment information surrounding the landing platform 200.

In some embodiments, the orientation information of the propeller blades 122 can be collected through the sensor of the aerial vehicle 100 and/or the sensor arranged at the landing platform 200.

In some embodiments, the processor 501 can also be configured to, if the propeller blades 122 are not within the preset area, perform one or more of the following operations to cause the propeller blades 122 to be in the preset area. The operations can include controlling the propeller blades 122 to rotate again and regenerating a control instruction based on the orientation information of the propeller blade, or controlling the execution mechanism of the landing platform 200 to push the propeller blades 122.

Exemplarily, the processor 501 can be configured to run the computer program stored in the memory 502 to, after the aerial vehicle 100 is parked on the landing platform 200, obtain the orientation information of the propeller blades 122 of the aerial vehicle 100, based on the orientation information of the propeller blades 122, controlling the propeller blades 122 to stop rotating in the preset area to cooperate with the landing platform 200 to accommodate the aerial vehicle 100.

In some embodiments, the landing platform can further include the block member. The aerial vehicle can include the plurality of propeller blades. The processor can also be configured to, if the movement position of the first propeller blade of the plurality of propeller blades is blocked by the block member, control the other propeller blades to continue to rotate to reduce the angle between the first propeller blade and the other propeller blades. The other propeller blades are the blades of the plurality of propeller blades except for the first propeller blade.

In some embodiments, the processor can also be configured to, if the position relationship between the first propeller blade and the other propeller blades meets the preset condition, control the other propeller blades to stop rotating.

In some embodiments, the position relationship between the first propeller blade and the other propeller blades meeting the preset condition can include determining that the position relationship between the first propeller blade and the other propeller blades meets the preset condition based on image detection and/or determining that the position relationship between the first propeller blade and the other propeller blades meets the preset condition based on the mapping of the motor stalled current.

In some embodiments, the rotation of the other propeller blades can include the rotation driven by the motor and/or the rotation due to the external force applied by the execution mechanism of the landing platform.

In some embodiments, generating a control instruction based on the orientation information of the propeller blade, the control instruction being used to control the propeller blades to stop rotating in the preset area, can include, if the position relationship between the first propeller blade and the other propeller blades meets the preset condition, controlling the plurality of propeller blades to move to the preset area and stop rotating based on the control instruction.

In some embodiments, controlling the plurality of propeller blades to move to the preset area and stop rotating based on the control instruction can include driving the plurality of propeller blades to rotate based on the motor and/or applying the external force to the propeller blades to cause the propeller blades to rotate based on the execution mechanism of the landing platform.

Exemplarily, the execution mechanism and/or block member of the landing platform can be the cabin cover of the landing platform, an assembly connected to the cabin cover of the landing platform, or another assembly connected to the landing platform.

In some embodiments, the aerial vehicle 100 includes a body 110, the arm 140, and the propeller base 121. The plurality of arms 140 can extend from the body 110 to support the plurality of propeller bases 121. The propeller blades 122 can be arranged at the propeller base 121. The preset area can be a polygon. Any angle point of the polygon can be at the position of the propeller base 121.

In some embodiments, obtaining the orientation information of the propeller blade 122 of the aerial vehicle 100 can include obtaining the image of the propeller blades 122 during the rotation process of the propeller blades 122 and determining the orientation information of the propeller blades 122 according to the imaging position of the propeller blades 122 in the image.

In some embodiments, obtaining the orientation information of the propeller blade 122 of the aerial vehicle 100 can include obtaining the orientation information of the propeller blade 122 through the sensor carried by the landing platform 200.

In some embodiments, the processor 501 can also be configured to, if the propeller blades 122 are not within the preset area after stopping the rotation, control the propeller blades 122 to rotate again to cause the propeller blades 122 to be in the preset area.

Those skilled in the art can understand that for convenience and simplicity, for the operation process of the control device 500, reference can be made to the corresponding description of the method embodiments of the present disclosure, which is not repeated.

Embodiments of the present disclosure further provide a control system. The control system can include the control device of embodiments of the present disclosure.

Embodiments of the present disclosure further provide a computer-readable storage medium. The computer-readable storage medium can store a computer program that, when executed by the processor 501, causes the processor 501 to implement the control method of the aerial vehicle 100 of embodiments of the present disclosure.

The computer-readable storage medium can be an internal storage unit of the chassis of the movable platform above, such as a hard drive or memory of the chassis of the movable platform. The computer-readable storage medium can also be an external storage device of the chassis of the movable platform, such as a plug-in hard drive, smart media card (SMC), secure digital (SD) card, flash card, etc., equipped on the chassis of the movable platform.

The terms used in the present disclosure are only for describing specific embodiments and are not intended to limit the present disclosure. As used in the present disclosure and the appended claims, unless the context clearly indicates otherwise, the singular forms “a,” “an,” and “the” are intended to include the plural forms.

The term “and/or” used in the present disclosure and the appended claims can refer to any combination and all possible combinations of the listed items and include these combinations.

The above are merely some embodiments of the present disclosure. However, the scope of the present application is not limited to this. Those skilled in the art can easily think of various equivalent modifications or replacements within the technical scope of the present disclosure, These modifications or replacements should be within the scope of the present disclosure. Therefore, the scope of the invention should conform to the scope of the claims.

What is claimed is:

1. An alternate landing planning method comprising:
obtaining an alternate landing position configuration instruction to set an alternate landing position other than a primary landing position of an aerial vehicle; and
determining, according to the alternate landing position configuration instruction, a current parking position of the aerial vehicle as the alternate landing position.

2. The planning method according to claim 1, wherein determining the current parking position as the alternate landing position includes:
determining the alternate landing position based on information sensed by at least one of a positioning sensor of the aerial vehicle or an external positioning sensor carried by a landing platform, the landing platform including a carrier platform configured to provide the primary landing position.

3. The planning method according to claim 1, further comprising:
outputting prompt information indicating to place the aerial vehicle at a designated area.

4. The planning method according to claim 1, further comprising:
obtaining alternate landing position distribution information around the primary landing position; and
in response to the alternate landing position distribution information not satisfying a preset alternate landing position distribution condition, outputting prompt information indicating to place the aerial vehicle at a designated area.

5. The planning method according to claim 1, further comprising:
Selecting, based on a selection operation of a user, a set alternate landing position near the primary landing position;
obtaining another alternate landing position other than the set alternate landing position; and
updating, in response to receiving an alternate landing position update instruction, the set alternate landing position to the another alternate landing position.

6. The planning method according to claim 1, further comprising:
outputting user guidance information of the alternate landing position, the user guidance information including description information of a parking position of the aerial vehicle.

7. The planning method according to claim 1, further comprising, before determining the current parking position of the aerial vehicle as the alternate landing position:
controlling the aerial vehicle to take off from the primary landing position; and
controlling the aerial vehicle to land and park in a designated landing area.

8. The planning method according to claim 7, wherein the designated landing area is determined based on a joystick control operation on a remote controller of the aerial vehicle or an area selection operation on a control interface of the aerial vehicle.

9. The planning method according to claim 1, further comprising:
displaying, on a display interface, one or more of an identifier of the alternate landing position, an identifier of the primary landing position, an identifier of a position of the aerial vehicle, position information of the alternate landing position, position information of the primary landing position, position information of the position of the aerial vehicle, and relative position relationship information;
wherein the relative position relationship information includes relative position relationship between any two of the alternate landing position, the primary landing position, and the position of the aerial vehicle.

10. The planning method according to claim 1, further comprising:
obtaining state information of the aerial vehicle at the parking position; and
generating, in response to the state information not satisfying a preset state condition, prompt information indicating that setting of the alternate landing position is abnormal;
wherein the state information includes one or more of distance information of the parking position relative to the primary landing position, tilt information of the aerial vehicle, and obstacle distribution information of a surrounding environment of the aerial vehicle.

11. A landing platform control method comprising:
collecting orientation information of a propeller blade of an aerial vehicle parked at a landing platform; and
generating a control instruction based on the orientation information of the propeller blade, the control instruction being used to control the propeller blade to stop rotating in a preset area.

12. The control method according to claim 11,
wherein the landing platform further includes a block member, and the propeller blade is one of a plurality of propeller blades of the aerial vehicle;
the control method further comprising:
controlling the block member to approach and block movement of one propeller blade of the plurality of propeller blades to reduce an angle between the one propeller blade and another propeller blade of the plurality of propeller blades while the other propeller blade rotates.

13. The control method according to claim 12, wherein generating the control instruction includes:
controlling, in response to position relationship between the one propeller blade and the other propeller blade satisfying a preset condition, the plurality of propeller blades to move to the preset area and stop rotation based on the control instruction.

14. The control method according to claim 13, wherein controlling the plurality of propeller blades to move to the preset area and stop the rotation based on the control instruction includes at least one of, for a propeller blade of the plurality of propeller blades:
controlling a motor to drive the propeller blade to rotate; or
controlling an execution mechanism of the landing platform to apply an external force to rotate the propeller blade.

15. The control method according to claim 11, further comprising:
controlling a cabin cover of the landing platform to move to shield the aerial vehicle.

16. The control method according to claim 11, wherein:
the aerial vehicle includes a body, a plurality of arms, and a plurality of propeller bases;
the plurality of arms extend outward from the body to support the plurality of propeller bases;
the propeller blade is one of a plurality of propeller blades mounted at the plurality of propeller bases; and
the preset area is a polygon, and any angle point of the polygon is at a position of one of the plurality of propeller bases.

17. The control method according to claim 11, wherein collecting the orientation information of the propeller blade includes:
collecting an image of the propeller blade during rotation of the propeller blade; and
determining the orientation information of the propeller blade according to an imaging position of the propeller blade in the image.

18. The control method according to claim 11, wherein:
the landing platform includes a sensor carried by a cabin cover; and
the sensor is configured to:
when the cabin cover is in an open state, face a parking area for carrying the aerial vehicle to obtain an image of the propeller blade of the aerial vehicle; and
when the cabin cover is in a shield state, monitor environment information around the landing platform.

19. A control device comprising:
one or more memories storing instructions; and
one or more processors operating separately or together to execute the instructions to:
obtain an alternate landing position configuration instruction to set an alternate landing position other than a primary landing position of an aerial vehicle; and
determine, according to the alternate landing position configuration instruction, a current parking position of the aerial vehicle as the alternate landing position.

20. The control device according to claim 19, wherein the one or more processors further operate separately or together to execute the instructions to:
determine the alternate landing position based on information sensed by at least one of a positioning sensor of the aerial vehicle or an external positioning sensor carried by a landing platform, the landing platform including a carrier platform configured to provide the primary landing position.
